(19) United States
(12) Patent Application Publication
(10) Pub. No.: US 2025/0205825 A1
(43) Pub. Date: Jun. 26, 2025

(54) METHOD AND LASER CUTTING MACHINE FOR THE LASER CUTTING WORKPIECE PARTS FROM A WORKPIECE

(71) Applicant: TRUMPF Werkzeugmaschinen SE + Co. KG, Ditzingen (DE)

(72) Inventors: Daniel Mock, Kernen (DE); Antoine Bastien, Crans (CH)

(21) Appl. No.: 19/078,393

(22) Filed: Mar. 13, 2025

Related U.S. Application Data
(63) Continuation of application No. PCT/EP2023/074183, filed on Sep. 4, 2023.

(30) Foreign Application Priority Data
Sep. 16, 2022 (DE) 10 2022 123 798.2

(51) Int. Cl. B23K 26/38

(52) U.S. Cl. CPC B23K 26/38

(57) ABSTRACT

A method for laser cutting of workpiece parts from at least one workpiece using a laser beam of a laser cutting machine includes ascertaining at least one material quality parameter of a material quality of the at least one workpiece, determining at least one laser cutting parameter for the laser cutting of the workpiece parts based on the at least one material quality parameter, and performing the laser cutting of the workpiece parts from the at least one workpiece using the laser beam of the laser cutting machine using the at least one laser cutting parameter.

### CROSS REFERENCE TO RELATED APPLICATIONS

This application is a continuation of International Application No. PCT/EP2023/074183 (WO 2024/056427 A1), filed on Sep. 4, 2023, and claims benefit to German Patent Application No. DE 10 2022 123 798.2, filed on Sep. 16, 2022. The aforementioned applications are hereby incorporated by reference herein.

### FIELD

Embodiments of the present invention relate to a method and a laser cutting machine for the laser cutting of workpiece parts from at least one workpiece using a laser beam.

### BACKGROUND

It is known that the quality of a laser-cut workpiece essentially depends on the quality of the raw material used and on the cutting pattern produced in the laser cutting process. This cutting pattern in turn depends on the material quality, in particular on the choice of material and the condition of the workpiece used. This condition can also change depending on the type and duration of storage of the workpieces, for example due to corrosion. It has been found that as a result of these variations in quality of the workpieces used, a cutting pattern is typically produced which in turn may exhibit certain deficiencies in quality, in particular with regard to the length of the burr, the roughness of the surface, the color of the cut (tarnishing), or uncontrolled burn-out (in the case of flame cutting).

### SUMMARY

Embodiments of the present invention provide a method for laser cutting of workpiece parts from at least one workpiece using a laser beam of a laser cutting machine. The method includes ascertaining at least one material quality parameter of a material quality of the at least one workpiece, determining at least one laser cutting parameter for the laser cutting of the workpiece parts based on the at least one material quality parameter, and performing the laser cutting of the workpiece parts from the at least one workpiece using the laser beam of the laser cutting machine using the at least one laser cutting parameter.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of a laser cutting machine according to an exemplary embodiment of the invention;

FIG. 2 shows a schematic view of a laser cutting device as part of the laser cutting machine of FIG. 1 according to some embodiments;

FIG. 3 shows a schematic view of a control device of the laser cutting device of FIG. 2 according to some embodiments;

FIG. 4 shows a schematic view of a laser cutting process according to a first exemplary embodiment of the invention using the laser cutting machine of FIG. 1;

FIG. 5 shows a schematic view of a laser cutting process according to a second exemplary embodiment of the invention using the laser cutting machine of FIG. 1; and

FIG. 6 shows a schematic view of a laser cutting process according to a third exemplary embodiment of the invention using the laser cutting machine of FIG. 1.

### DETAILED DESCRIPTION

Embodiments of the invention can mitigate the above-mentioned deficiencies in quality of workpiece parts cut in a laser cutting process of a laser cutting machine.

According to some embodiments, a method for the laser cutting of workpiece parts from at least one workpiece using a laser beam of a laser cutting machine is provided. The method has the following steps:
ascertaining at least one material quality parameter of a material quality of the at least one workpiece,
determining at least one laser cutting parameter for the laser cutting of the workpiece parts, wherein the at least one laser cutting parameter is determined on the basis of the at least one ascertained material quality parameter, and
laser cutting the workpiece parts from the at least one workpiece using the laser beam of the laser cutting machine, wherein the at least one determined laser cutting parameter is used for the laser cutting process.

According to embodiments of the invention, a material quality of the workpiece or workpieces intended for laser processing is first ascertained, wherein one or more material quality parameters are ascertained which can indicate the material quality in order to establish comparability between different material qualities. On the basis of the one or more material quality parameters, one or more laser cutting parameters are then determined for the laser cutting process. Of course, the determination of the laser cutting parameters does not have to be carried out solely on the basis of the at least one material quality parameter, but also on the basis of other influencing factors, such as the working range of the laser cutting machine. It is crucial that the one or more material quality parameters are taken into account when determining the laser cutting parameters. For the laser cutting process, at least one previously determined laser cutting parameter is then used to carry out a laser cutting process adapted to the material quality. Consequently, the laser cutting process is adapted to the quality of the material of the workpiece or workpieces used by the method according to embodiments of the invention in order to avoid quality deficiencies in the produced workpiece parts. The laser cutting process itself can then proceed according to a nesting plan, which specifies the geometry of the workpiece parts to be cut out and can specify positioning on the workpiece.

Various applications can be used to determine the laser cutting parameters on the basis of the material quality parameters so that a high or at least a required degree of quality of the workpiece parts is achieved. For example, a database can be used for determining the at least one laser cutting parameter, in which optimal laser cutting parameters are specified on the basis of material quality parameters (and possibly the other bases for determining the laser cutting parameters mentioned later). Such a database can, for example, be based on empirical values and/or experiments. However, it can also be based on a simulation. It is also conceivable to carry out a simulation of different laser cutting parameters for determined material quality parameters, in particular combinations of material quality parameters, and to determine one or more laser cutting parameters, in particular a set of laser cutting parameters, depending on a simulation result regarding the quality of the cut-out workpiece parts. Additionally or alternatively, for example, artificial intelligence, in particular machine learning, can be used in determining the at least one laser cutting parameter.

In the present case, a workpiece is understood to mean in particular a workpiece plate or workpiece sheet which has its greatest extent in a horizontal plane and is arranged with a thickness in the vertical plane orthogonal thereto. A workpiece can, in particular, be a workpiece panel. Such a workpiece can also be referred to as a machined workpiece if it contains workpiece parts that are connected to the workpiece by a predetermined breaking point. Such a predetermined breaking point can be designed in particular in the form of a web between the workpiece parts and the workpiece or a remaining workpiece skeleton. The predetermined breaking point ensures, on the one hand, that the workpiece with all workpiece parts can be safely removed from the laser cutting machine and, on the other hand, that the workpiece parts can be easily detached from the workpiece and thus removed from the laser cutting machine.

The laser cutting process can be at least partially automated, in particular fully automated. The laser cutting machine used can, in particular, be designed as a flatbed machine tool, in particular a 2D laser flatbed machine. The flatbed machine tool separates the workpiece parts, the shape of which can be predetermined by a nesting plan of the flatbed machine tool, from the rest of the workpiece by means of laser cutting. The workpiece parts are therefore cut out of the workpiece in particular using a laser beam. However, the predetermined breaking point may remain, which connects each workpiece part with the rest of the workpiece, which is also referred to as the skeleton and may represent recyclable waste. There may also be several predetermined breaking points between each workpiece part and the workpiece. The workpiece processed in this way can now be fed into the sorting process in or on the laser cutting machine, since the workpiece parts are still attached to the skeleton of the workpiece by means of the predetermined breaking point. The breaking of the target breaking point or the detachment of the workpiece parts from the skeleton of the workpiece can be carried out manually, semi-automatically, or fully automatically. A tool such as a vibrating unit, a vibration hammer, or a drill can be used for sorting. A vibrating unit or vibration hammer uses vibration to create periodically repeated vibrations or impacts on the workpiece, so that the workpiece parts are released from the workpiece. The predetermined breaking point can be broken using a drilling machine by drilling at the predetermined breaking point or at a drilling point provided next to the workpiece part, in particular a microjoint.

It can be provided that the method further has the step of specifying a target workpiece part quality, wherein the determination of the at least one laser cutting parameter is carried out such that the predetermined target workpiece part quality is achieved in the laser cutting process. In other words, it can be provided that a required workpiece part quality is predetermined in the method. The target workpiece quality can in turn be made quantifiable by workpiece quality parameters in order to ensure comparability and evaluability. Then, the one or more laser cutting parameters can be determined in such a way that, on the basis of the material quality parameters, it can be ensured, in particular with a predefined expected value, that (at least) the required workpiece part quality is achieved during the laser cutting process. This makes the process particularly efficient because other disadvantages, such as slow laser cutting, high wear or high energy and cutting gas consumption, which can be the case with a laser cutting process with maximum quality requirements, are not accepted in favor of the maximum achievable workpiece part quality, which may not even be necessary for the subsequent processing or use of the workpiece parts.

It can also be provided that at least one machine condition parameter of a machine condition of the laser cutting machine is further ascertained and the at least one laser cutting parameter is also determined on the basis of the ascertained at least one machine condition parameter. As a result, a further parameter, which has been determined to be relevant for the workpiece part quality, can be included in the method according to embodiments of the invention in order to be able to ensure the production of workpiece parts of high, in particular required, workpiece part quality.

It can be provided that the at least one machine condition parameter indicates at least one maintenance status and/or operating status of the laser cutting machine. The maintenance status and the operating status provide information about how reliably or error-free the laser cutting machine is expected to work. Depending on this, countermeasures can be taken by determining the laser cutting one or more parameters. For example, high tolerances of the laser cutting machine due to insufficient or overdue maintenance can be counteracted by low laser cutting speeds and low laser cutting intensities as possible laser cutting parameters in order to compensate for the tolerances. However, in the case of an optimally or recently maintained laser cutting machine, the laser cutting parameters can be better determined on the basis of the one or more material quality parameters, because a negative influence of the machine condition can be largely excluded. The same applies to the operating status. This can, for example, indicate how long the laser cutting machine has been in operation overall or in an ongoing production cycle, whether it has already warmed up or whether a cold start is required for the laser cutting process, whether there are any possible contaminations, for example of a protective glass of the laser cutting machine, or defects and/or what the condition of individual components of the laser cutting machine is, for example the nozzles. Different modules or units of the laser cutting machine can be used to ascertain the machine condition parameters. For example, a maintenance documentation module, a control unit, a sensor, and/or a camera can be used to ascertain the maintenance status and/or the operating status. A possible example of a sensor is a stray light sensor, which can detect a thermal shift of the laser beam due to, for example, contamination of the protective glass through stray light analysis. Based on the degree of contamination determined on the basis of the stray light analysis, a machine condition parameter can be ascertained accordingly and used to determine at least one laser cutting parameter. A focus position control, which depends on laser power and beam-on time, can also be used to calculate the thermal shift. For example, a low laser cutting speed can then be selected as a laser cutting parameter in order to compensate for the contamination in terms of the workpiece part quality produced until it is eliminated.

It can be further provided that the at least one material quality parameter is ascertained on the basis of manufacturer workpiece data and/or measurement data from a measurement of the at least one workpiece by means of at least one sensor and/or at least one camera. It is particularly advantageous if both manufacturer workpiece data and measurement data are used in order to be able to determine as many different material quality parameters as possible in as much detail as possible, which advantageously creates a large amount of data for determining the one or more laser cutting parameters. The manufacturer workpiece data can sometimes provide different material quality parameters than the measurement data. It is also possible to verify and check the manufacturer workpiece data using the measurement data. In this way, mix-ups of workpieces, incorrect information in the workpiece data or expired information, for example no longer being rust-free after long-term storage or transport defects of the workpieces, can be detected and taken into account in the process. This ensures that the material quality is ascertained correctly and that the required target workpiece quality can be guaranteed by a suitable selection of the one or more laser cutting parameters.

It can also be provided that the at least one material quality parameter indicates at least one of a material composition, a grain size of the material, a surface quality, and/or a material condition. It has been shown that the above-mentioned material quality parameters have a high significance for the subsequent workpiece quality on the basis of the determined laser cutting parameters.

It can be further provided that the at least one laser cutting parameter indicates at least one of a laser cutting power, a laser cutting feed, a focus position, a focus diameter, a nozzle position, and/or a laser cutting gas pressure. It has been shown that the above laser cutting parameters are particularly suitable adjustment means in the laser cutting process for achieving, on the one hand, a required target workpiece quality and, on the other hand, for avoiding disadvantages in the laser cutting process.

In particular, it can be provided that the method also has the following further steps:
generating measurement data relating to the workpiece parts, the at least one workpiece and/or the laser cutting process by means of at least one sensor and/or at least one camera,
analyzing the measurement data to ascertain an actual workpiece part quality of the workpiece parts, and
adapting the at least one laser cutting parameter on the basis of the analyzed actual workpiece part quality, in particular compared to a predetermined target workpiece part quality.

By measuring the workpiece parts and/or the at least one workpiece and/or monitoring the laser cutting process, a verification of the achieved workpiece part quality is provided during or in-between the laser cutting process, wherein countermeasures are also taken during the laser cutting process by adapting the one or more laser cutting parameters, in particular if the workpiece part quality ascertained by analyzing the measurement data is below a predetermined target workpiece part quality. For example, in order to generate the measurement data, a light section can be taken to measure the burr height and/or a reflected light image of the cutting edge to determine the groove pattern and the tarnishing colors. The analysis of the measurement data to ascertain the actual workpiece quality can also be supported by artificial intelligence, in particular machine learning. For example, the analysis of sensor and/or camera images can become increasingly better in order to be able to ascertain the actual workpiece quality increasingly faster and more precisely. It is also possible to adapt the one or more laser cutting parameters if the workpiece quality is (significantly) higher than was predetermined, for example to speed up the laser cutting process. As already mentioned, high quality also comes with disadvantages in terms of process management, in particular in terms of process duration and the costs associated with laser cutting. If a certain high quality is not expected, it can be ensured that essentially exactly the desired workpiece part quality is produced. The one or more laser cutting parameters determined at the outset therefore represent only an initial configuration for the start of the laser cutting process or the initial laser cutting process. This initial configuration with one or more laser cutting parameters can be adapted as described above to a processing configuration that is determined for the further laser cutting process to achieve a predetermined target workpiece part quality.

In this case, it can be provided that the steps of generating, in particular measuring and/or monitoring, analyzing, and adapting, are repeated, in particular until the actual workpiece part quality corresponds at least to the predetermined workpiece part quality. This allows the laser cutting parameters to be adjusted step by step and continuously until the required target workpiece quality is achieved. Of course, measurement data can also be generated by measuring and/or monitoring and the measurement data can be analyzed to ascertain the actual workpiece part quality in order to ensure that the achieved actual workpiece part quality can be maintained in the further laser cutting process.

It can also be provided that the at least one sensor and/or the at least one camera comprises at least one of a slag removal unit for detecting a spray jet during laser cutting, a spark detection unit for detecting a spark size and/or spark brightness during laser cutting, a line spectroscopy sensor for detecting spectral lines during laser cutting, and a hyperspectral camera for detecting a temperature profile during laser cutting. The aforementioned detectors have proven to be particularly advantageous because they enable a precise ascertaining of the actual workpiece quality. They can also be used to advantageously monitor the laser cutting process. For example, an evaluation of the sparks when first cutting/inserting into the workpiece can be carried out, which allows the number and size of the sparks to be ascertained. A determination of the viscosity of the melt or what the spray jet looks like can also be used to analyze the melt removal and thus the actual workpiece quality. In addition to an advantageous evaluation of the line spectrum, the use of a hyperspectral camera, which offers the possibility of measuring in the larger wavelength range, e.g., a heat imprint, the slag removal can be detected and thus the cutting quality and the workpiece part quality.

In particular, it can be provided that the at least one sensor and/or the at least one camera is a multi-detection system having at least two of a sensor and/or a camera. Such a multi-detection system can improve the measurement data situation by increasing the amount of available data. Greater monitoring reliability is also provided in the event that a detection unit fails or does not provide usable measurement data. The increased quantity of measurement data ensures a more reliable and precise analysis of the measurement data to ascertain the actual workpiece quality.

The laser cutting machine is configured for the laser cutting of workpiece parts from at least one workpiece using a laser beam from a laser cutting head of the laser cutting machine, wherein the laser cutting machine has:
an ascertaining module for ascertaining at least one material quality parameter of a material quality of the at least one workpiece,
a determination module for determining at least one laser cutting parameter for the laser cutting of the workpiece parts, wherein the at least one laser cutting parameter is determined on the basis of the at least one ascertained material quality parameter, and
a control module for controlling the laser cutting of the workpiece parts from the at least one workpiece using the laser beam from the laser cutting head using the at least one determined laser cutting parameter.

In this case, features described herein with respect to the method also apply with respect to the laser cutting machine and vice versa.

Thus, a laser cutting machine according to embodiments of the invention brings with it the same advantages as have been explained in detail with reference to the method according to embodiments of the invention. In particular, the laser cutting machine can be designed or configured to carry out the method according to embodiments of the invention.

The modules of the laser cutting machine can, for example, each be implemented by a separate computer program code or by a common computer program code, by separate or common functional units of a computer and/or control units and/or other units. For example, the ascertaining module can be designed as a reading unit, such as a reading program code, a memory of a computer and/or a sensor and/or a camera of the laser cutting machine. It is also possible that individual modules are partially or completely implemented in a common module, for example the ascertaining module and the determination module. For example, the modules of the laser cutting machine can be implemented in a control device of the laser cutting machine.

It can be provided that the laser cutting machine also has a further ascertaining module for ascertaining a machine condition parameter of a machine condition of the laser cutting machine and the determination module is configured to determine at least one laser cutting parameter also on the basis of the at least one ascertained machine condition parameter.

It can be provided that the further ascertaining module is or has a machine documentation module by which the machine condition parameters are documented.

In particular, it can be provided that the laser cutting machine further has:
at least one sensor and/or at least one camera for generating measurement data relating to the workpiece parts, the at least one workpiece and/or the laser cutting process,
an analysis module for analyzing the measurement data to ascertain an actual workpiece part quality of the workpiece parts, and
an adaptation module for adapting the at least one laser cutting parameter on the basis of the ascertained actual workpiece part quality, in particular compared to a predetermined target workpiece part quality.

In addition to the modules mentioned, the laser cutting machine can of course have other modules and components. For example, this is the previously mentioned database, the artificial intelligence and/or a simulation module for determining the one or more laser cutting parameters, as well as a specification module for specifying the workpiece part quality, etc.

In the following description and the figures, the same reference signs are used in each case for identical or corresponding features.

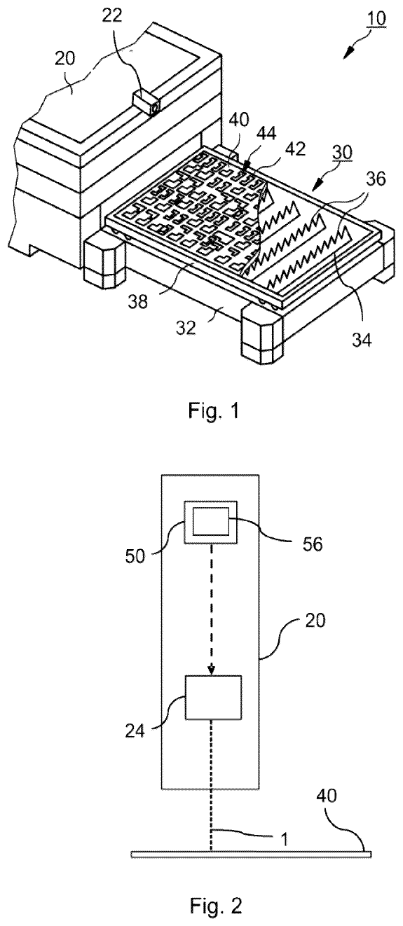

FIG. 1 shows a laser cutting machine 10 in the form of a laser cutting flatbed machine tool with a laser cutting device 20 in which a laser cutting process is carried out with a laser beam 1 (see FIG. 2). In particular, a focus of the laser beam 1 is guided by a control device 50 (see FIG. 2) of the laser cutting machine 10 along predetermined cutting contours 42 arranged in a cutting region over a plate-like workpiece 40, in particular a metal sheet extending substantially two-dimensionally, in order to cut out workpiece parts 44 with specific shapes predetermined according to a nesting plan. The nesting plan can be predetermined by a control plan for the control device 50.

The laser cutting machine 10 here also comprises, by way of example, a removal device 30. The removal device 30 is shown open here for the sake of better illustration, but can alternatively be partially or completely enclosed like the laser cutting device 20 in FIG. 1. The removal device 30 comprises, for example, a pallet changer 32. The pallet changer 32 is designed to position one or a plurality of pallets 38 during production. A workpiece 40 to be cut (as a raw or starting material), in particular a workpiece sheet, can be placed and stored on a pallet 38 and introduced into the housing of the laser cutting device 20 for the laser cutting process. After the cutting process is completed, the pallet 38 can be moved out of the laser cutting device 20 with a processed workpiece 40, as shown in FIG. 1, so that, according to the control plan, the cut workpiece parts 44 can be sorted from the remaining workpiece 40 and removed from the laser cutting machine 10.

FIG. 2 shows the laser cutting process in the laser cutting device 20. A laser cutting head 24, which is controlled by the control device 50 and emits the laser beam 1 for cutting out the workpiece parts 44 from the workpiece 40 onto the workpiece 40, can be freely positioned in the cutting region so that the laser beam 1 can be guided substantially along any two-dimensional cutting contours 42 over the workpiece 40 to be cut. In this case, a cutting contour 42 for the laser beam 1 is predetermined in the control device 50 based on the nesting plan in order to cut out the workpiece parts 44 from the workpiece 40. The nesting plan indicates the arrangement of the individual workpiece parts 44 in the workpiece 40, as shown in FIG. 1. In addition, the nesting plan can comprise the predetermination of insertion points and predetermined first cuts for inserting the laser beam 1 and guiding the laser beam 1 along the first cut to the cutting contour 42 (not shown).

During laser cutting, the laser beam 1 heats the metal of the workpiece 40 along the predetermined cutting contours 42 until it melts. A cutting gas jet, in particular made of nitrogen or oxygen, can exit the laser cutting head 24 in the region of the laser beam 1 and pushes the molten material of the workpiece 40 downwards and out of the gap that is formed. The workpiece 40 is thus completely severed by the laser beam 1 during cutting.

To cut out a workpiece part 44, the laser beam 1 is moved along the predetermined cutting contours 42 of the respective workpiece 40. This begins at one of the previously mentioned insertion points, which lie outside the workpiece 40, and then approaches the contour of the workpiece 40, in particular in an arc-shaped first cut.

In the exemplary embodiment shown, the pallet 38 has a workpiece support. The workpiece support has a plurality of support webs 34 which run transversely, in particular perpendicularly, to the direction of insertion of the workpiece 40 into the laser cutting device 20 and are aligned parallel to one another. The support webs 34 form supporting regions 36 on which the workpiece 40 is placed or supported. The supporting regions 36 thus form a grid of regions that can influence the laser cutting process and the removal of the workpiece parts 44 cut out thereon.

FIG. 1 further shows a camera 22 of the laser cutting machine 10, which is arranged, by way of example, on the laser cutting device 20 or its housing. The camera 22 can be part of the ascertaining module 51 of the control device 50 of the laser cutting machine or can be connected thereto. The camera 22 is shown here purely by way of example and for the sake of better illustration directed at the removal device 30 and can alternatively or additionally also be directed at the laser cutting device 20, in particular arranged within the housing of the laser cutting device 20. In addition, sensors can also be used alternatively or in addition to the camera 22.

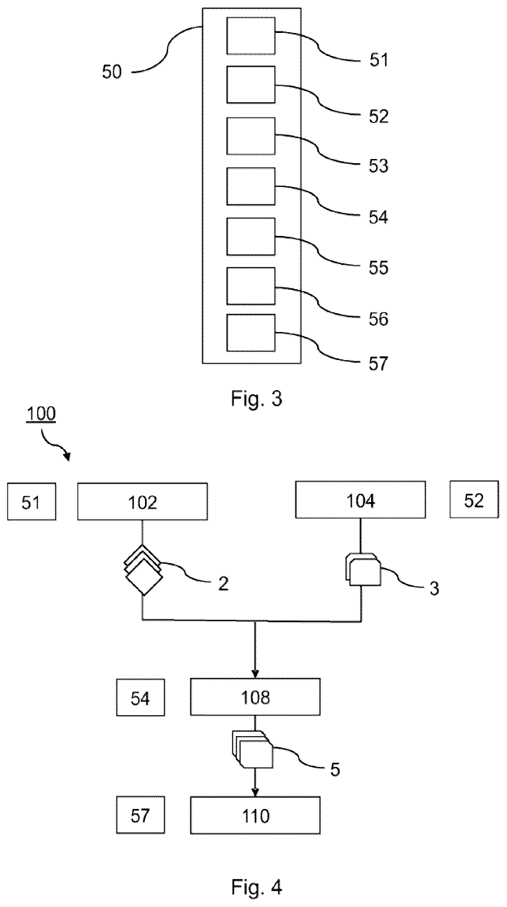

FIG. 3 shows, in a schematic and exemplary manner, the schematic control device 50 of the laser cutting device 20 of the laser cutting machine 10 with its respective modules. In the present example, these are an ascertaining module 51, a further ascertaining module 52, a specification module 53, a determination module 54, an analysis module 55, an adaptation module 56, and a control module 57. Alternatively, however, fewer modules can be used, as will become clear from the exemplary embodiments of the method 100 according to embodiments of the invention explained below.

FIG. 4 schematically shows a first exemplary embodiment of a method 100 for laser cutting workpiece parts 44 from at least one workpiece 40 using the laser beam 1 from the laser cutting head 24 of the laser cutting device 20 of the laser cutting machine 10 of FIG. 1.

In a first step 102 of the method 100, material quality parameters 2 of a material quality of a workpiece 40, from which workpiece parts 44 are to be cut out according to the predetermined nesting plan, are ascertained by means of the ascertaining module 51. This can preferably be carried out based on manufacturer workpiece data and measurement data from a measurement of the at least one workpiece 40 by means of a sensor and/or the camera 22, which send their measurement data to the ascertaining module 51. The measurement data can be recorded when the workpiece 40 is in the laser cutting machine 10, for example on the removal device 30 or in the laser cutting device 20. The ascertaining module 51 ascertains the material quality parameters 2 based on the measurement data and the manufacturer workpiece data. Different material quality parameters 2 ascertained in this way can, for example, indicate a material composition, a grain size of the material, a surface quality, and/or a material condition. These material quality parameters 2 make it possible to describe very precisely the material quality of the workpiece 40 from which the workpiece parts 44 are to be cut out of the workpiece 40 by the laser cutting machine 10 in accordance with the nesting plan.

In parallel, before or after step 102, step 104 of the method 100 is carried out, in which the further ascertaining module 52 ascertains machine condition parameters 3, which can indicate, for example, a maintenance status and/or operating status of the laser cutting machine 10, in particular of the laser cutting device 20. The further ascertaining module 52 can, for example, be or contain a machine documentation module, in particular for documenting the maintenance of the laser cutting machine 10, by means of which the machine condition parameters 3 are documented.

The ascertained material quality parameters 2 and the machine condition parameters 3 are transmitted to the determination module 54, which in a step 108 of the method 100 ascertains a plurality of laser cutting parameters 5 adapted to the previously ascertained material quality parameters 2 and machine condition parameters 3 for the laser cutting process of laser cutting the workpiece parts 44 from the workpiece 40. The different laser cutting parameters 5 determined in this manner can, for example, indicate a laser cutting power, a laser cutting feed, a focus position, a focus diameter, a nozzle position, and a laser cutting gas pressure for execution by the control module 57 of the control device 50 of the laser cutting device 20.

In step 110 of the method 100, the control module 57 uses the previously determined laser cutting parameters 5 for controlling the laser cutting process of the workpiece parts 44 from the workpiece 40 using the laser beam 1. This ensures that the laser cutting parameters 5 during laser cutting are adapted to the material quality of the workpiece 40 and the machine condition of the laser cutting machine 10, so that a high workpiece part quality of the manufactured workpiece parts 44 is achieved.

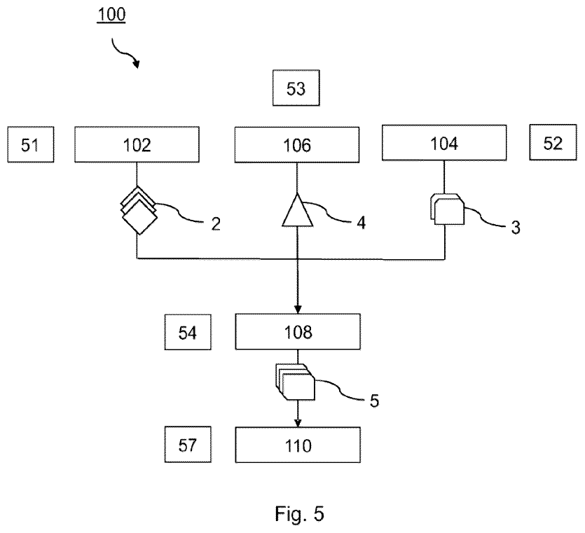

In a second exemplary embodiment of the method 100 according to FIG. 5, a specification module 53 of the control device 50 is also used. This specification module 53 specifies a required target workpiece part quality 4 in a step 106. This predetermined target workpiece quality 4 is transmitted to the determination module 54. The determination module 54 also adapts the laser cutting parameters 5 to the required target workpiece part quality 4 in order to ensure that this is realized on the manufactured workpiece parts 44 with the ascertained material quality parameters 2 and the ascertained machine condition parameters 3.

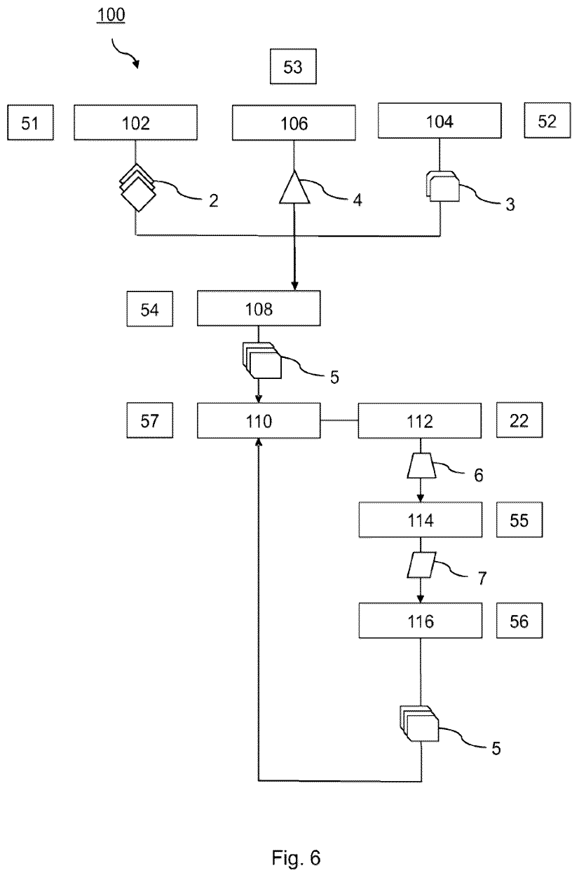

A third exemplary embodiment of the method 100 is embodied by FIG. 6, which also uses the analysis module 55 and the adaptation module 56 of the control device 50. First, the method 100 is carried out according to the second exemplary embodiment of FIG. 5 with the steps 102, 104, 106, 108, and 110. Unlike in FIG. 5, however, this only determines an initial configuration of the determined laser cutting parameters 5 for an initial laser cutting process, which is carried out in step 110.

In a further step 112, this initial laser cutting process is monitored by the at least one camera 22 and/or the at least one sensor. Measurement data 6 are thus recorded or generated. These measurement data 6 are transmitted to the analysis module 55, which analyzes them in order to ascertain an actual workpiece part quality 7 of the workpiece parts 44 cut out so far. By comparing the actual workpiece part quality 7 with the predetermined target workpiece part quality 4, it is determined whether the laser cutting parameters 5 of the initial configuration should be adapted. If the actual workpiece part quality 7 does not yet correspond to or exceed the predetermined target workpiece part quality 4, this adaptation is carried out in step 116 of the method 100 by the adaptation module 56. The laser cutting parameters 5 adjusted in this way are fed back to step 110, i.e., the laser cutting process, in order to continue an interrupted laser cutting process with the adjusted laser cutting parameters 5 or to continue an ongoing laser cutting process with the adjusted laser cutting parameters 5. It is also possible that the steps 112, 114, 116 are repeated until the actual workpiece part quality 7 corresponds at least to the predetermined target workpiece part quality 4. If this is the case, the laser cutting machine 10 has assumed its processing configuration with laser cutting parameters 5 that are optimally coordinated with regard to the material quality and the machine condition in order to produce an actual workpiece part quality 7 that essentially corresponds to the target workpiece part quality 4.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for laser cutting of workpiece parts from at least one workpiece using a laser beam of a laser cutting machine, the method comprising:
ascertaining at least one material quality parameter of a material quality of the at least one workpiece,
determining at least one laser cutting parameter for the laser cutting of the workpiece parts based on the at least one material quality parameter, and
performing the laser cutting of the workpiece parts from the at least one workpiece using the laser beam of the laser cutting machine using the at least one laser cutting parameter.

2. The method according to claim 1, further comprising specifying a target workpiece part quality, wherein the determining the at least one laser cutting parameter is carried out such that the target workpiece part quality is achieved in the laser cutting.

3. The method according to claim 1, further comprising ascertaining at least one machine condition parameter of a machine condition of the laser cutting machine, wherein the determining the at least one laser cutting parameter is further based on the at least one machine condition parameter.

4. The method according to claim 3, wherein the at least one machine condition parameter indicates at least one maintenance status and/or operating status of the laser cutting machine.

5. The method according to claim 1, wherein the ascertaining the at least one material quality parameter is is based on manufacturer workpiece data and/or measurement data from a measurement of the at least one workpiece by using at least one sensor and/or at least one camera.

6. The method according to claim 1, wherein the at least one material quality parameter indicates at least one of a material composition, a grain size of a material of the at least one workpiece, a surface quality, or a material condition.

7. The method according to claim 1, wherein the at least one laser cutting parameter indicates at least one of a laser cutting power, a laser cutting feed, a focus position, a focus diameter, a nozzle position, or a laser cutting gas pressure.

8. The method according to claim 1, further comprising:
generating measurement data relating to the workpiece parts, the at least one workpiece, and/or the laser cutting by using at least one sensor and/or at least one camera,
analyzing the measurement data to ascertain an actual workpiece part quality of the workpiece parts, and
adapting the at least one laser cutting parameter based on the actual workpiece part quality.

9. The method according to claim 8, wherein the steps of generating, analyzing, and adapting are repeated, until the actual workpiece part quality corresponds to a target workpiece part quality.

10. The method according to claim 8, wherein the at least one sensor and/or the at least one camera comprises at least one of a slag remover for detecting a spray jet during the laser cutting, a spark detector for detecting a spark size and/or spark brightness during the laser cutting, a line spectroscopy sensor for detecting spectral lines during the laser cutting, or a hyperspectral camera for detecting a temperature profile during the laser cutting.

11. The method according to claim 8, wherein the at least one sensor and/or the at least one camera is a multi-detection system having at least two of a sensor and/or a camera.

12. A laser cutting machine for laser cutting of workpiece parts from at least one workpiece using a laser beam from a laser cutting head of the laser cutting machine, the laser cutting machine comprising:
an ascertaining module for ascertaining at least one material quality parameter of a material quality of the at least one workpiece,
a determination module for determining at least one laser cutting parameter for the laser cutting of the workpiece parts based on the at least one ascertained material quality parameter, and
a controller for controlling the laser cutting of the workpiece parts from the at least one workpiece using the laser beam from the laser cutting head using the at least one laser cutting parameter.

13. The laser cutting machine according to claim 12, further comprising a further ascertaining module for ascertaining a machine condition parameter of a machine condition of the laser cutting machine, wherein the determination module is configured to determine the at least one laser cutting parameter based on the at least one machine condition parameter.

14. The laser cutting machine according to claim 13, wherein the further ascertaining module comprises a machine documentation module by which the machine condition parameter is documented.

15. The laser cutting machine according to claim 12, further comprising:
at least one sensor and/or at least one camera for generating measurement data relating to the workpiece parts, the at least one workpiece, and/or the laser cutting,
an analysis module for analyzing the measurement data to ascertain an actual workpiece part quality of the workpiece parts, and
an adaptation module for adapting the at least one laser cutting parameter based on the actual workpiece part quality.
